(19) United States
(12) Patent Application Publication
(10) Pub. No.: US 2008/0155841 A1
(43) Pub. Date: Jul. 3, 2008

(54) DRAWING MACHINE

(76) Inventor: Po-Lin Ho, Kuan Yin Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/618,082

(22) Filed: Dec. 29, 2006

(51) Int. Cl. B43L 13/10

(52) U.S. Cl. 33/23.08

(57) ABSTRACT

A drawing machine includes a plate, a clamping device, a drawing device and a driving device. The clamping device includes two jaws movable on a first surface of the plate, a following element movable on a second surface of the plate and a linkage for connecting the jaws to the following element. The drawing device includes a following element attached to the second surface of the plate. The driving device includes first and driving elements at a shaft. For clamping, the first driving element drives the following element of the clamping device for a different distance than the second driving element drives the following element of the drawing device. For releasing, the first driving element drives the following element of the clamping device as fast as the second driving element drives the following element of the drawing device.

### BACKGROUND OF INVENTION

1. Field of Invention

The present invention relates to a drawing machine.

2. Related Prior Art

Referring to FIGS. 13 and 14, there is shown a conventional drawing machine 1 including a clamping device and a drawing device. The clamping device 1 includes a lower plate, two rails, two slides, two jaws 3, two rods, an upper plate, a yoke and a cylinder 4. The rails extend on the top of the lower plate so that the rails get closer to each other from a first end to a second end. The slides are movable along the rails. The jaws 3 are carried on the slides. The rods are raised from the slides. The upper plate is attached to the lower plate. The yoke is movable on the upper plate and connected to the rods inserted through the upper plate. The cylinder 4 is a pneumatic or hydraulic cylinder for moving the yoke on the upper plate. The cylinder 4 can move the yoke. The yoke can move the rods. The rods move the slides. The slides move the jaws 3. The jaws 3 get closer to each other for clamping a rod or pipe to be drawn. The drawing device includes two following elements and a driving element 2. The following elements are attached to the bottom of the lower plate. The driving element 2 includes a shaft and a ridge extending on the shaft and acting as a cam. The ridge is engaged with the following elements. As the shaft is rotated, the following elements are moved by the ridge so that the clamping device is moved. Thus, the rod or pipe is drawn. However, the conventional drawing machine is not reliable for reasons. Firstly, it is difficult to keep the pressure of the fluid in the cylinder 4 at an intended value. Secondly, there is drag in the transmission of the fluid in the cylinder 4 and a related piping. A related circuit for controlling the cylinder 4 is vulnerable to malfunctioning.

The present invention is therefore intended to obviate or at least alleviate the problems encountered in prior art.

### SUMMARY OF INVENTION

According to the present invention, a drawing machine includes a plate, a clamping device, a drawing device and a driving device. The clamping device includes two jaws movable on a first surface of the plate, a following element movable on a second surface of the plate and a linkage for connecting the jaws to the following element. The drawing device includes a following element attached to the second surface of the plate. The driving device includes first and driving elements at a shaft. For clamping, the first driving element drives the following element of the clamping device for a different distance than the second driving element drives the following element of the drawing device. For releasing, the first driving element drives the following element of the clamping device as fast as the second driving element drives the following element of the drawing device.

An advantage of the drawing machine according to the present invention is reliability for not including any hydraulic or pneumatic cylinder that would fluctuates in the pressure of the fluid and drags in transmission of the fluid.

Another advantage of the drawing machine according to the present invention is a simple structure including a small amount of elements.

Other advantages and features of the present invention will become apparent from the following description referring to the drawings.

### BRIEF DESCRIPTION OF DRAWINGS

The present invention will be described via detailed illustration of two embodiments referring to the drawings.

FIG. 1 is a side view of a drawing machine according to the first embodiment of the present invention.

FIG. 2 is a perspective view of the top of a clamping device of the drawing machine shown in FIG. 1.

FIG. 3 is a perspective view of the bottom of the clamping device shown in FIG. 1.

FIG. 4 is a top view of a driving device of the drawing machine shown in FIG. 1.

FIG. 5 is a top view of the drawing machine shown in FIG. 1.

FIG. 6 is a top view of the drawing machine in another position than shown in FIG. 5.

FIG. 7 is a perspective view of the top of a clamping device of a drawing machine according to the second embodiment of the present invention.

FIG. 8 is a perspective view of the bottom of the clamping device shown in FIG. 7.

FIG. 9 is a top view of the clamping device shown in FIG. 7.

FIG. 10 is a side view of the clamping device shown in FIG. 9.

FIG. 11 is a top view of the clamping device in another position than shown in FIG. 9.

FIG. 12 is a side view of the clamping device shown in FIG. 11.

FIG. 13 is a side view of a conventional drawing machine.

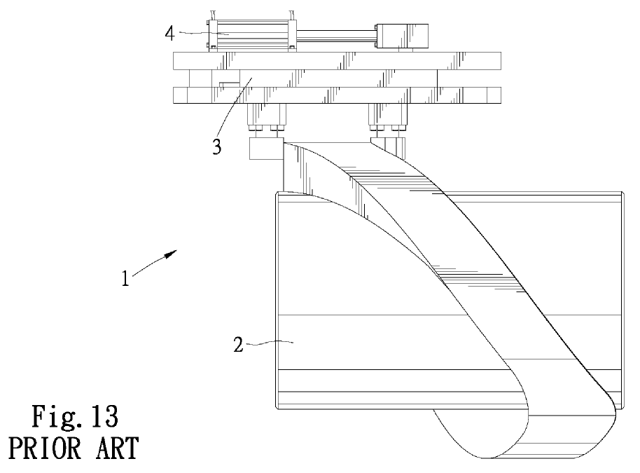

FIG. 14 is an exploded view of a clamping device of the conventional drawing machine shown in FIG. 13.

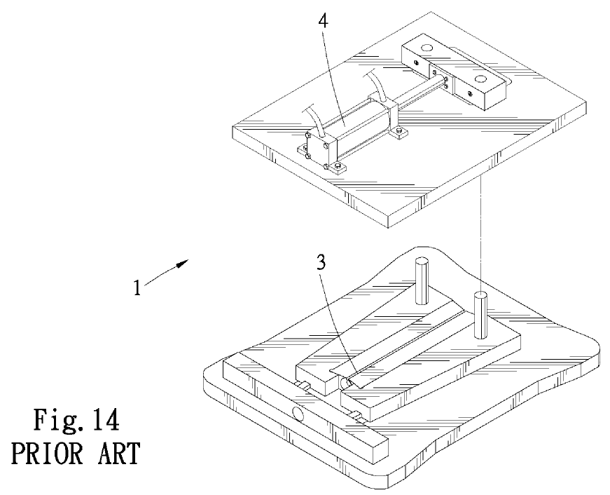

### DETAILED DESCRIPTION OF EMBODIMENTS

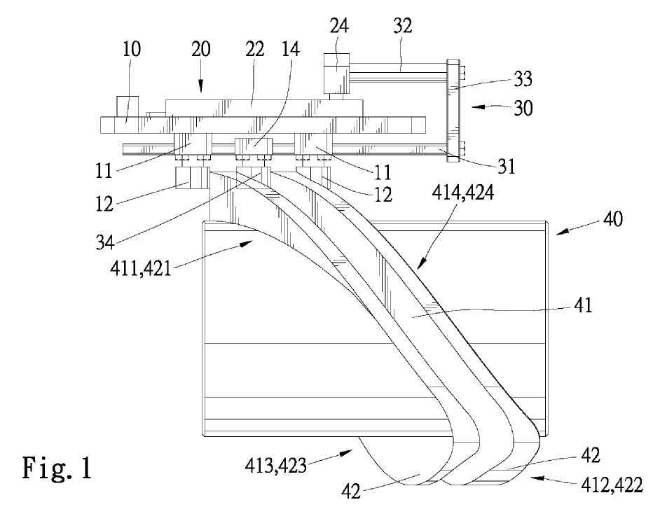

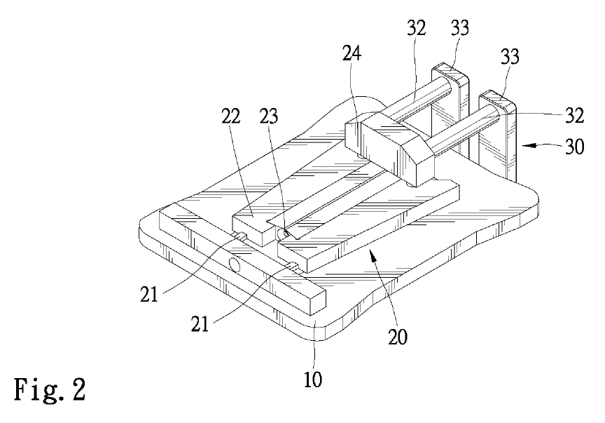

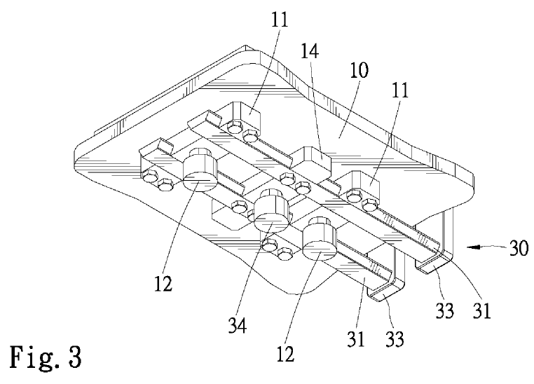

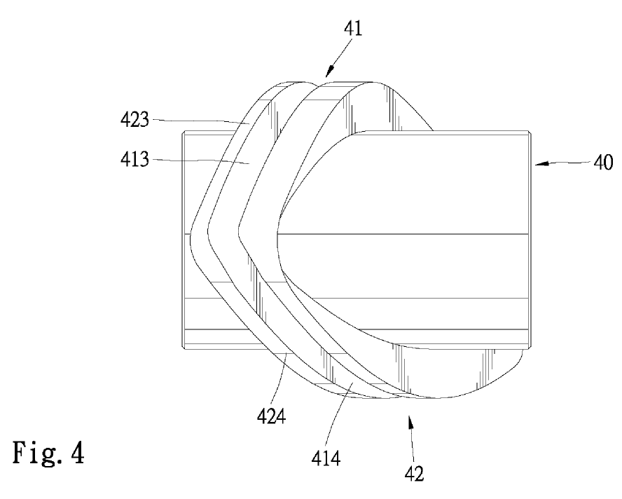

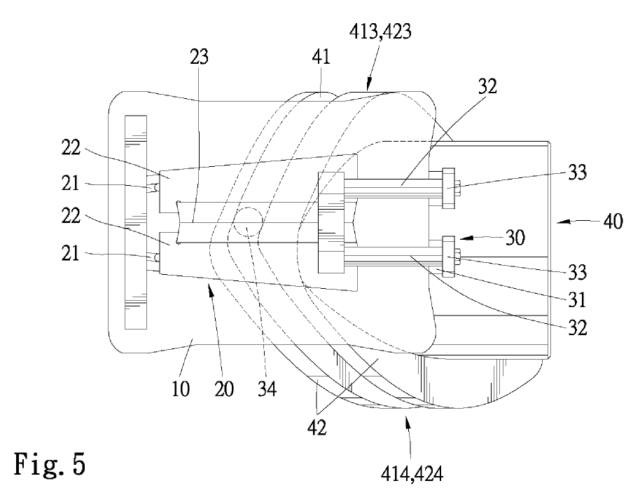

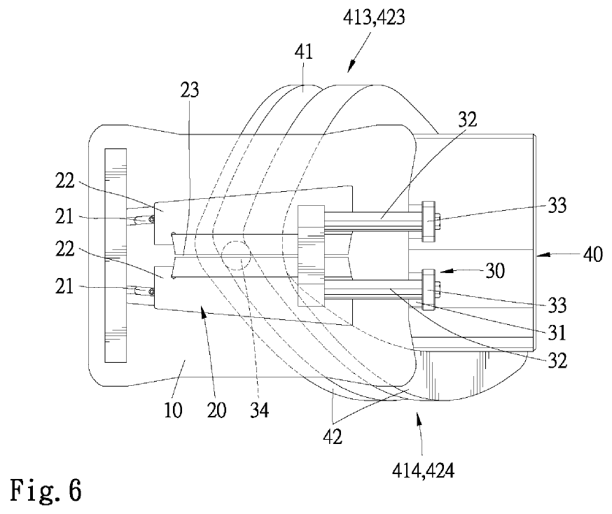

Referring to FIGS. 1 through 6, there is shown a drawing machine according to a first embodiment of the present invention. The drawing machine includes a clamping device 20 and a drawing device 30. The clamping device 20 is used to clamp a rod or pipe to be drawn. The drawing device 30 is used to move the clamp device 20 and therefore draw the rod or pipe.

The clamping device 20 includes a plate 10, two rails 21, two upper slides 22, two jaws 23, an upper yoke 24, two beams 32, two columns 33, two lower slides 31, two guides 11, a lower yoke 14 and a following element 34. The rails 21 extend on the top of the plate 10 so that the rails 21 get closer to each other from a first end to a second end. The upper slides 22 are movable along the rails 21. The jaws 23 are carried on the upper slides 22. The upper yoke 24 is used to move the upper slides 22. The beams 32 are connected to the yoke 24.

The columns 33 are connected to the beams 32. The lower slides 31 are connected to the columns 33. Each of the lower slides 31 is a dovetail. The lower yoke 14 is used to move the lower slides 31. The following element 34 is connected to the lower yoke 14. The guides 11 are attached to the bottom of the plate 10. Each of the guides 11 defines two dovetail grooves for receiving the lower slides 31 so that the lower slides 31 are movable in a rectilinear path because of the guides 11.

Moreover, the clamping device 20 includes a groove 41 defined in a shaft 40 and used like a cam. The following element 34 is movable in and along the groove 41 so that the following element 34 rectilinearly moves when the shaft 40 rotates.

The drawing device 30 includes two following elements 12 attached to the guides 11 and a ridge 42 extending on the shaft 40 and acting like a cam. The ridge 42 is engaged with the following elements 12 so that when the shaft 40 rotates, the following elements 12 rectilinearly move. The following elements 12 move the drawing device 20. Therefore, the rod or pipe is drawn.

The spirit of the present invention is the inclusion of the groove 41 and the ridge 42 on the common shaft 40. As the shaft 40 rotates, the groove 41 selectively causes the jaws 23 to move or remain still on the plate 10 while the ridge 42 causes the plate 10 to move.

The groove 41 includes a clamping section 413 and a releasing section 414. The ridge 42 includes a clamping section 423 and a releasing section 424. The clamping section 41 3 of the groove 41 causes the following element 34 to move for a different distance than the clamping section 423 of the ridge 42 causes the following elements 12 to move so that the following element 34 moves with respect to the following elements 12. That is, the jaws 23 move with respect to the plate 10. Therefore, the jaws 23 get closer to each other for clamping the rod or pipe.

The releasing section 414 of the groove 41 causes the following element 34 to move as fast as the releasing section 424 of the ridge 42 causes the following elements 12 to move so that the following element 34 remains still relative to the following elements 12. That is, the jaws 23 remain still with respect to the plate 10. Therefore, the jaws 23 do not get closer to each other.

In the first embodiment, the groove 41 is defined in the ridge 42. In another embodiment, the groove 41 may be defined in the shaft 40 outside the ridge 42. In still another embodiment, the ridge 42 may be replaced with a groove for receiving a single following element 12. In still another embodiment, the groove 41 may be replaced with a ridge engaged with two following elements 34.

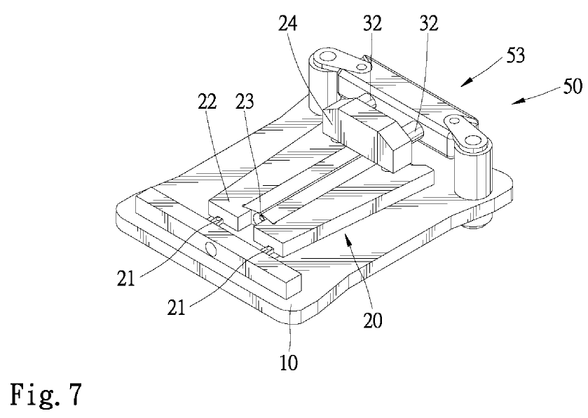

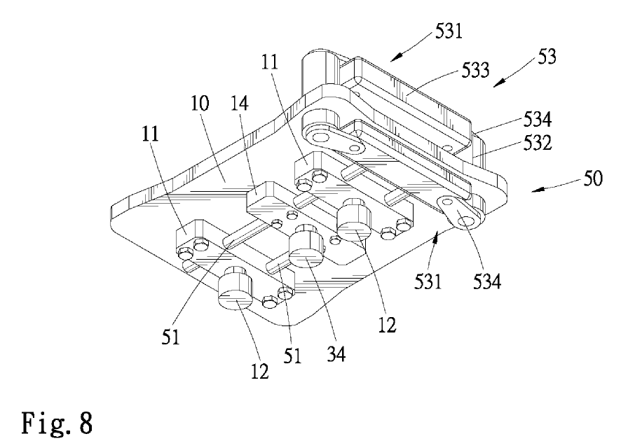

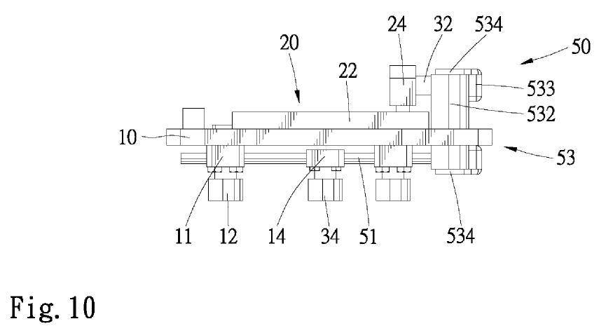

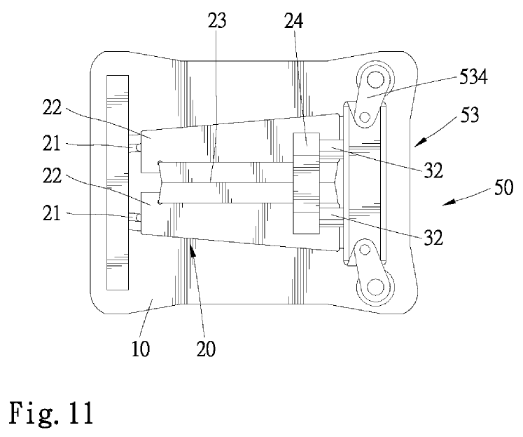

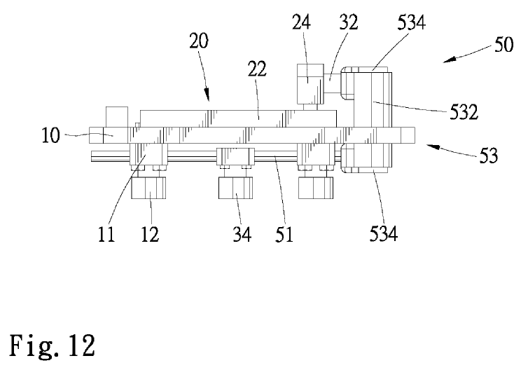

Referring to FIGS. 7 through 12, there is shown a drawing machine according to a second embodiment of the present invention. The second embodiment is like the first embodiment except several features. Firstly, two lower slides 51 are used instead of the lower slides 31. The lower slides 51 are circular beams. Secondly, a linkage 53 is used instead of the columns 33. The linkage 53 includes an upper crossbar 533 connected to the beams 32, a lower crossbar 533 connected to the lower slides 51 and two connecting units 531 for joining the upper and lower crossbars 533. Each of the connecting units 531 includes a shaft 532 inserted through the plate 10, an upper crank 534 connected to the upper crossbar 533 and a lower crank 534 connected to the lower crossbar 533.

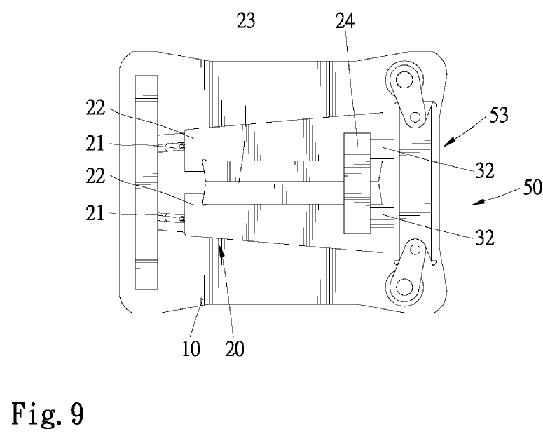

Referring to FIGS. 9 through 12, the movement of the following element 34 with respect to the following elements 12 causes the lower yoke 14 and therefore the lower slides 51 to move. The lower slides 51 move the lower crossbar 533. The lower crossbar 533 causes the upper crossbar 533 to move via the linkage 53. The upper crossbar 533 moves the beams 32. The beams 32 eventually cause the jaws 23 to get closer to each other.

An advantage of the drawing machine according to the present invention is reliability for not including any hydraulic or pneumatic cylinder that would fluctuates in the pressure of the fluid and drags in transmission of the fluid. Another advantage of the drawing machine according to the present invention is a simple structure including a small amount of elements.

The present invention has been described via the detailed illustration of the embodiments. Those skilled in the art can derive variations from the embodiments without departing from the scope of the present invention. Therefore, the embodiments shall not limit the scope of the present invention defined in the claims.

What is claimed is:

1. A drawing machine comprising:
a plate comprising a first surface and a second surface;
a clamping device comprising two jaws movable on the first surface of the plate, at least one following element movable on the second surface of the plate and a linkage for connecting the jaws to the following element;
a drawing device comprising at least one following element attached to the second surface of the plate;
a driving device comprising a shaft, a first driving element at the shaft and a second driving element at the shaft for driving the following element of the drawing device for a different distance than the first driving element drives the following element of the clamping device in a clamping mode and as fast as the first driving element drives the following element of the clamping device in a releasing mode.

2. The drawing machine according to claim 1 wherein the first driving element is a groove for receiving the following element of the clamping device.

3. The drawing machine according to claim 1 wherein the first driving element is a ridge and the clamping device comprises two following elements engaged with the ridge.

4. The drawing machine according to claim 1 wherein the second driving element is a groove for receiving the following element of the drawing device.

5. The drawing machine according to claim 1 wherein the second driving element is a ridge, and the drawing device comprises two following elements engaged with the ridge.

6. The drawing machine according to claim 1 wherein one of the first and second driving elements is a groove while the remaining one of the first and second driving elements is a ridge.

7. The drawing machine according to claim 6 wherein the groove is defined in and along the ridge.

8. The drawing machine according to claim 1 wherein the clamping device comprises two rails extending on the first surface of the plate so that the jaws get closer to each other while traveling along the rails from an end to another under the control of the following element thereof via the linkage.

9. The drawing machine according to claim 8 wherein the linkage comprises two upper slides for carrying the jaws along the rails.

10. The drawing machine according to claim 9 wherein the linkage comprises an upper yoke connected to the upper sides.

11. The drawing machine according to claim 10 wherein the linkage comprises two beams connected to the upper yoke, two lower slides connected to the following element of the clamping device and two columns for connecting the beams to the lower slides.

12. The drawing machine according to claim 11 wherein the linkage comprises a lower yoke for connecting the lower sides to the following element of the clamping device.

13. The drawing machine according to claim 10 wherein the linkage comprises two beams connected to the upper yoke, a first crossbar connected to the beams, two lower slides connected to the following element of the clamping device, a second crossbar connected to the lower slides and two connecting units for joining the first and second crossbars.

14. The drawing machine according to claim 13 wherein each of the connecting units comprises a shaft inserted through the plate, a first crank extended from the shaft and connected to the first crossbar, a second crank extended from the shaft and connected to the second crossbar.

15. The drawing machine according to claim 13 wherein the lower slides are dovetails.

16. The drawing machine according to claim 13 wherein the slides are circular rods.

17. The drawing machine according to claim 13 wherein the linkage comprises a lower yoke for connecting the lower sides to the following element of the clamping device.
